(19) United States
(12) Patent Application Publication
(10) Pub. No.: US 2025/0329028 A1
(43) Pub. Date: Oct. 23, 2025

(54) THERMAL IMAGE ENHANCEMENT BY PERSPECTIVE SIMULATION

(71) Applicant: JSC Yukon Advanced Optics Worldwide, Vilneus (LT)

(72) Inventor: Vladimir Dasiukevich, Glasgow (GB)

(21) Appl. No.: 18/641,592

(22) Filed: Apr. 22, 2024

(51) Int. Cl. G06T 7/194; F41G 1/38; G02B 23/12; G06T 7/13; G06T 11/00; G06V 10/14; G06V 10/764; G06V 20/50

(52) U.S. Cl. CPC G06T 7/194; G02B 23/12; G06T 7/13; G06T 11/00; G06V 10/14; G06V 10/764; G06V 20/50; F41G 1/38; G06T 2207/10048

(57) ABSTRACT

An optical device, such as a rifle scope or a spotting scope, includes an optical sensor to receive electromagnetic radiation reflected from a scene; an image processor to comprising hardware circuitry; a memory for storing instructions that when executed cause the image processor to perform operations for adding perspective enhancement to an object in a scene. The operations include generating a digital image of the scene from the received infrared radiation, identifying an object of interest within the digital image of the scene, and altering the object of interest to add dimensional perspective to the object of interest in the digital image. The optical device also includes a display screen to display the digital image of the scene with the object of interest being enhanced.

### BACKGROUND

A thermal imager is an optical device that combines a thermographic camera and an aiming reticle. Thermal imagers can be mounted on a variety of small arms as well as some heavier weapons. Unlike optical scopes, thermal sights do not rely on visible light, allowing them to provide images of objects and other scenery at night or other dark environments. The thermal imager benefits from the difference in temperatures between the environment and any source of heat to create visual contrast between the two.

### SUMMARY

In some implementations, a thermal imaging method includes receiving, at an optical sensor of an optical device, infrared radiation reflected from a scene, generating, by an image processor, a digital image of the scene from the received infrared radiation, identifying, by the image processor, an object of interest within the digital image of the scene, altering, by the image processor, the object of interest to add dimensional perspective to the object of interest in the digital image, and displaying, on a display of the optical device, the digital image of the scene with the object of interest.

In some implementations, a thermal imaging optical device includes an optical sensor to receive infrared radiation reflected from a scene, an image processor to comprising hardware circuitry, a memory for storing instructions that when executed cause the image processor to perform operations including: generating a digital image of the scene from the received infrared radiation, identifying an object of interest within the digital image of the scene, and altering the object of interest to add dimensional perspective to the object of interest in the digital image; and a display screen to display the digital image of the scene with the object of interest.

In some implementations, the device and/or method includes altering the object of interest to add dimensional perspective to the object of interest comprises varying the brightness level of the object of interest to add a shading effect to the object of interest.

In some implementations, the device and/or method includes identifying a region of interest adjacent to the object of interest; and changing a brightness level of the region of interest adjacent to the object of interest to add a shadow effect to the region of interest adjacent to the object of interest.

In some implementations, the device and/or method designates previously identified object as a first object of interest and further comprises identifying a second object of interest from the digital image of the scene, determining that the second object of interest is behind the first object of interest, altering the second object of interest to add dimensional perspective to the object of interest in the digital image based on the second object of interest being behind the first object of interest, and displaying the second object of interest on the display.

In some implementations, the device and/or method includes altering the second object of interest to add dimensional perspective to the object of interest in the digital image based on the second object of interest being behind the first object of interest by accentuating a boundary between the first object of interest and the second object of interest using edge detection.

In some implementations, the device and/or method includes altering the second object of interest to add dimensional perspective to the object of interest in the digital image based on the second object of interest being behind the first object of interest by performing dynamic focus adjustment on the second object of interest to add a blur to the second object of interest, the blur to create a perception that the second object of interest is out of focus.

In some implementations, the device and/or method includes altering the second object of interest to add dimensional perspective to the object of interest in the digital image based on the second object of interest being behind the first object of interest by increasing the relative brightness of the first object of interest relative to the brightness of the second object of interest.

In some implementations, the device and/or method includes identifying a background of the scene, and blurring the background of the scene to enhance the object of interest.

In some implementations, the device and/or method includes identifying a foreground of the scene; and blurring the foreground of the scene to enhance the object of interest.

In some implementations, the device and/or method includes identifying a background of the scene, isolating the object of interest from the background of the scene, and flatting the background of the scene to enhance the object of interest.

Other aspects includes apparatuses, systems, and computer programs for performing the actions of the aforementioned method.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 is a schematic diagram illustrating a right-side, cut-away view of an example digitally-based, optical scope configured in a conventional, optically-based scope form factor, according to an implementation of the present disclosure.

FIG. 2 is a schematic diagram illustrating a top, cut-away view of the example digitally-based, optical scope of FIG. 1 configured in a conventional, optically-based scope form factor, according to an implementation of the present disclosure.

FIG. 3 is a schematic diagram of an example processor for a thermal imaging device for enhancing digital images by simulating perspective in a thermal image displayed or output by the thermal imager in accordance with some implementations of the present disclosure.

FIG. 4 is a process flow diagram for enhancing thermal images by simulating perspective in a thermal image displayed or output by the optical imager in accordance with some implementations of the present disclosure.

FIGS. 5A-4B are an example thermal images before and after perspective simulation enhancement in accordance with some implementations of the present disclosure.

FIG. 6 is an example infrared image that includes several image processing techniques that add perspective enhancement in accordance with some implementations of the present disclosure.

Like reference numbers and designations in the various drawings indicate like elements.

### DETAILED DESCRIPTION

The following detailed description describes techniques performed by an optical (e.g., thermal or night vision) imaging device, and a optical imaging device itself, for enhancing digital images using perspective simulation. Digital images are enhanced using image processing techniques described herein to add perspective to one or more objects of interest or regions of interest. Adding perspective to an object of interest, for example, can add information about the object that the user may find useful, such as relative size of the object, relative distance, etc. In addition, enhancing thermal images with perspective simulation allows a digital image to begin to resemble an image formed from visible light, thereby enhancing the use experience.

Note, while this disclosure is focused on configurations and functionality associated with a digitally-based imaging device sensitive to thermal electromagnetic radiation (for example, IR), as will be appreciated by those of ordinary skill in the art, the described subject matter is also applicable to implementations of other digital-based imaging devices sensitive to any other type of detectable electromagnetic radiation (for example, ultraviolet (UV) and visible/ambient/daylight, night-vision, etc.). These other implementations are considered to be within the scope of this disclosure.

This disclosure describes an optical device, such as a scope, that include a processor to perform image processing techniques for enhancing an object of interest to have perspective, compared to other objects and background, so that the object of interest stands out in the display screen of the optical device.

Features of the disclosure include determining an object (or zone) of interest in an infrared/thermal vision image and enhancing the image such that the object (or zone) of interest is distinguished from the background, for example, enhance depth perspective and/or dimensionality, brightness/contrast, shading, artificial light, etc.

Various techniques can be used individually or in combination to render the perspective enhancement, including object recognition to distinguish or detect objects in the image, image processing to perform blurring, darkening, shading, brightness, sharpness, color enhancement, color removal, light source additions, etc. The image processing and object recognition can involve the use of machine learning models to determine a “class” or “category” of objects or features. The class or category of features can be used 1) for object recognition, and 2) for how the class or category can be processed for perspective enhancement. Categories and classes can also be used to provide object recognition information to the operator. For example, a class of an object can be determined, which then allows an object recognition system to identify the object itself more specifically. The object's features can then be determined to provide higher granularity information to the user. As an example, if an elk is the object of interest, the image recognition (or object recognition) system can identify a mammal as the class or category. Then, from there, the object recognition system can determine that the object is an elk based on features of the object. The object recognition system can use ML techniques to differentiate an elk from a deer or other antlered animals. Then the object recognition system can determine information about the elk, like a sex of the elk or an age or size, etc.

Information about the object can also be user input based, for example, selected by the operator (touch, gesture recognition). For example, the user can provide information about the object based on the user's own knowledge.

The image processing can also involve sharpening and restoration to create an enhanced image from the original image.

As mentioned before, the image processing can involve using machine learning models to enhance object (or zone) borders, brightness and contrast to maximize the detail and informative value.

Enhancing objects in infrared (IR) images requires specialized techniques that consider IR imagery's unique traits, including temperature variations, emissivity differences, and lighting conditions. Effectiveness of these methods depends on the image's specifics, camera, and the target object.

Below are some known methods:

### Contrast Enhancement:

Histogram Equalization: This method redistributes the pixel intensities in the image's histogram to enhance the contrast and improve visibility;
Adaptive Histogram Equalization: Similar to histogram equalization, but it adapts the process to different regions of the image, which can be especially useful for images with varying lighting conditions;
Sharpening: this method increases contrast between edges;
Unsharp Masking: This involves creating a high-pass filtered version of the image and subtracting it from the original image to enhance edges and fine details;
Laplacian Sharpening: It enhances edges by emphasizing the high-frequency components of the image;

### Smoothing and Noise Reduction:

Gaussian Blur: Applying a Gaussian blur can help reduce noise and small irregularities in an image, making the object stand out more;
Median Filtering: This is effective for removing salt-and-pepper noise while preserving edges and details;

### Edge Detection and Segmentation:

Canny Edge Detection: Detects edges in an image, which can help highlight the boundaries of the object;
Sobel Operator: Another edge detection method that emphasizes edges by calculating gradients in the image;

### Color Enhancement:

Color Balance Adjustment: Adjusting the color balance can improve the appearance of an object by correcting color casts.

Selective Color Adjustment: Modifying specific color channels can help enhance the object's appearance.

### Retouching and Spot Removal:

Clone Stamp Tool: This method allows copying pixels from one part of the image to another, which can be useful for removing distracting elements around the object.

### Local Adaptive Methods:

Since IR images can have varying lighting conditions and temperature gradients, applying local adaptive techniques can enhance object details while accounting for these variations.

### Super-Resolution for IR Images:

Single Image Super-Resolution: Using algorithms, you can enhance the resolution of the image, making the object details clearer.

### Denoising Techniques:

IR images can suffer from specific types of noise. Applying denoising methods tailored for IR data can improve the image quality and object visibility.

### Anomaly Detection Algorithms:

In IR images, objects with abnormal temperatures can be considered anomalies. Implementing anomaly detection algorithms can help highlight such objects.

Below are some known methods that integrate ML and AI for IR image enhancement:

### Deep Learning-Based Super-Resolution:

Utilize convolutional neural networks (CNNs) to upscale IR images, enhancing object details and overall image quality through learned features.

### Object Detection and Segmentation:

Train object detection models (like Faster R-CNN or YOLO) on annotated IR data to accurately locate and highlight specific objects in IR images.

### Transfer Learning for Feature Extraction:

Adapt pre-trained deep learning models (such as ResNet or VGG) to extract relevant features from IR images, aiding in better object recognition.

### Style Transfer for IR Enhancement:

Apply style transfer techniques to adjust the visual appearance of IR images, emphasizing object details and improving overall aesthetics.

### Adaptive Contrast Enhancement Using RL:

Use reinforcement learning to adaptively adjust contrast enhancement parameters in real-time, optimizing object visibility in varying conditions.

### Attention Mechanisms for Object Enhancement:

Incorporate attention mechanisms in deep models to focus on relevant object regions, enhancing their representation and visibility.

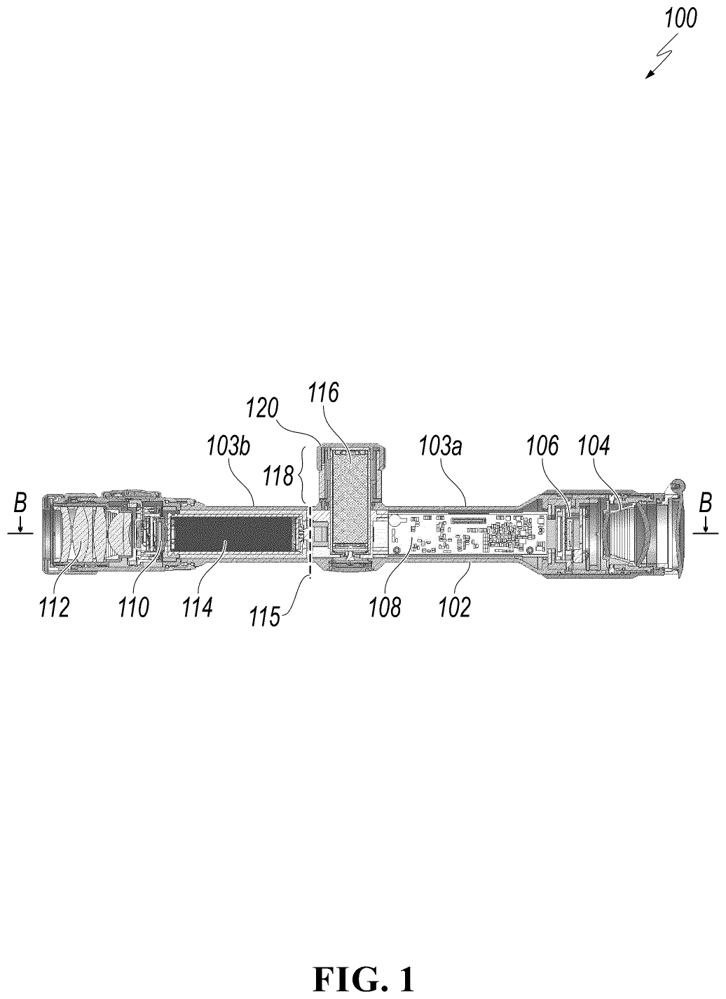

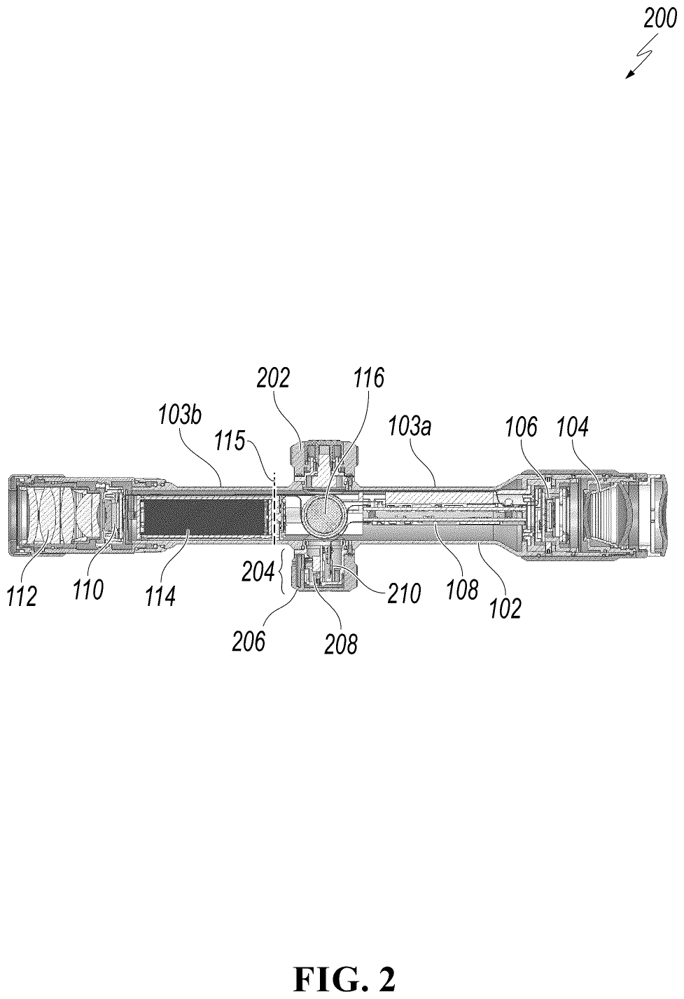

FIG. 1 is a schematic diagram illustrating a right-side, cut-away view 100 of an example digitally-based, thermal scope 101 configured in a conventional, optically-based scope form factor, according to an implementation of the present disclosure. The illustrated digitally-based, thermal scope 101 in FIG. 1 includes a tube-shaped body 102, receiving optics 104, receiving optical sensor 106, processing electronics 108, viewing computer display 110, viewing optics 112, internal rechargeable battery 114, and user-replaceable battery 116 (within battery turret 118 and secured with a removable battery turret cap 120). Refer to FIG. 2 for two additional turret-type assemblies not displayed in FIG. 1 (that is, 202 and 204). While FIGS. 1 and 2 describe thermal imaging devices, such devices are used as an example. Implementations of the present embodiments are applicable to other types of imaging devices, including but not limited to night-vision devices.

Tube-shaped body 102 is configured to permit mounting on equipment (for example, a firearm or tripod) using mounting systems similar to those used in mounting optically-based imaging devices. For example, the tube-shaped body 102 can be mounted to equipment at approximately positions 103 a and 103 b using a ring-type mounting system.

At a high-level, receiving optics 104 and receiving optical sensor 106 gather incoming electromagnetic radiation (for example, infrared (IR) light) for computer processing. The optical sensor 1006 can be a thermal sensor or IR sensor. Data generated by the receiving optical sensor 106 (for example, a charged coupled device (CCD), complementary metal-oxide-semiconductor (CMOS), or quanta image sensor (QIS)) is processed by processing electronics 108 into image data to be recreated/represented on viewing computer display 110 (for example, a color/monochrome liquid crystal display (LCD) or organic light-emitting diode (OLED) display, or other similar/suitable display) and viewed through viewing optics 112.

Internal rechargeable battery 114 is used to provide power to components and functions associated with the illustrated digitally-based, thermal scope 101. For example, the internal rechargeable battery 114 can be used to power the receiving optical sensor 106, processing electronics 108 (and associated provided functionality), viewing computer display 110, data transfer interfaces (for example, universal serial bus (USB), FIREWIRE, and WIFI), control mechanisms (for example, an integrated, rotary-type single control mechanism described in FIG. 2), and other functions consistent with this disclosure (for example, displaying a reticle on the viewing computer display 110 and wired/wireless integration with a mobile computing device). In some implementations, the internal rechargeable battery 114 can include lead-acid, nickel-cadmium (NiCd), nickel-metal hydride (NiMH), lithium-ion (Li-ion), lithium-ion polymer (Li-ion polymer), or other suitable battery technologies consistent with this disclosure. In some implementations, the internal rechargeable battery 114 can be recharged from power supplied by a data transfer interface (for example, a USB port) or the user-replaceable battery 116. For example, processing electronics 108 can be configured to detect a low-charge state of the internal rechargeable battery 114 and pull power from the user-replaceable battery 116 to charge the internal rechargeable battery 114 to a minimum charge state (if possible).

In some implementations, the digitally-based, thermal scope 101 can be configured to use power from the user-replaceable battery 116 until reaching a minimum charge state, at which point the digitally-based, thermal scope 101 can switch to the internal rechargeable battery 114 (if of a sufficient charge state) or to be gracefully shut down due to lack of power. Once a charged user-replaceable battery 116 is re-installed, the digitally-based, thermal scope 101 can switch power consumption back to the user-replaceable battery 116. The user-replaceable battery 116 can be used to extend allowable time-of-use for the digitally-based, thermal scope 101. For example, a user can hot-swap the user-replaceable battery 116 when discharged with a fresh battery to keep the digitally-based, thermal scope 101 operating. In other implementations, the digitally-based, thermal scope 101 can be configured to use power from the internal rechargeable battery 114 until reaching a minimum charge state, at which point the digitally-based, thermal scope 101 can switch to the user-replaceable battery 116 (if present) or to be gracefully shut down due to lack of power. In some implementations, modes of battery operation (that is, primary and secondary battery usage) can be selectable by a user depending upon their particular needs.

In some implementations, an external power supply could power the digitally-based, thermal scope 101 and recharge the internal rechargeable battery 114 and user-replaceable battery 116 (if rechargeable). For example, the processing electronics 108 can be configured to determine, if external power is available (for example, using a USB port or other external port (not illustrated)) and whether the internal rechargeable battery 114 or user-replaceable battery 116 is in a low-power state. If power is available, power can be directed to recharge the internal rechargeable battery 114 or user-replaceable battery 116. In some implementations, the processing electronics 108 can trigger an indicator (for example, light-emitting diode (LED), audio chirp, viewing computer display 110, or other visual/audio indicator) that the internal rechargeable battery 114 or user-replaceable battery 116 is (or is about to be) discharged or is charging. In some implementations, the processing electronics 108 can be configured to transmit data to a mobile computing device to display a message to a user that the internal rechargeable battery 114 or user-replaceable battery 116 is discharged and needs replacement or is recharging. In some implementations, a rechargeable user-replaceable battery 116 can include lead-acid, nickel-cadmium (NiCad), nickel-metal hydride (NiMH), lithium-ion (Li-ion), lithium-ion polymer (Li-ion polymer), or other suitable battery technologies consistent with this disclosure.

In some implementations, the internal rechargeable battery 114 is not user replaceable and must be replace by an authorized service center. In other implementations, the tube-shaped body 102 can be configured to be separable (for example, at 115) to permit user replacement of the internal rechargeable battery 114. For example, once a rechargeable battery exceeds a certain number of recharge cycles, the battery is incapable of holding a desirable amount of charge. In this case, a user might with to replace the depleted internal rechargeable battery 114. In a particular example, the tube-shaped body 102 could be in two-piece configuration that is screwed together (for example, at 115) once the internal rechargeable battery 114 is installed. In this configuration, the two pieces of the tube-shaped body 102 can be unscrewed, separated, the internal rechargeable battery 114 replaced with a new battery, and the two pieces of the tube-shaped body 102 screwed back together. Other attachment mechanisms for the two pieces of the tube-shaped body 102 that are consistent with this disclosure are considered to be within the scope of this disclosure.

Battery turret 118 is configured to hold the user-replaceable battery 116. The removable battery turret cap 120 is used to secure the user-replaceable battery 116 within the battery turret 118. In some implementations, the user-replaceable battery 116 can be either rechargeable or non-rechargeable and varying form factors, such as a 123A, CR2032, AA, and AAA).

In some implementations, the battery turret cap 120 can be a pop-off, friction fit, or screw-type cap. In some implementations, the battery turret cap 120 can be retained to the digitally-based, thermal scope 101 using a wire loop, elastic band, or other retention mechanism to prevent the battery turret cap 120 from becoming separated from the digitally-based, thermal scope 101. In typical implementations, the battery turret cap 120 (or battery compartment 110) is configured with one or more O-rings or other seals to provide a water- and dust-proof compartment for the user-replaceable battery 116.

In some implementations, processing electronics 108 can also be configured to provide other functionality consistent with this disclosure. For example, processing electronics 108 can be configured to provide WIFI, USB, streaming video, firmware upgrades, connectivity with mobile computing devices, control interfaces, and other functionality consistent with this disclosure associated with the digitally-based, thermal scope 101.

FIG. 2 is a schematic diagram illustrating a top, cut-away view 200 of the example digitally-based, thermal scope 101 of FIG. 1 configured in a conventional, optically-based scope form factor, according to an implementation of the present disclosure. As illustrated in FIG. 2, the digitally-based, thermal scope 101 includes an integrated, push/rotary-type single control mechanism turret (control) 202 and data transfer interface turret 204.

Control 202 can provide integrated control functionality associated with the digitally-based, thermal scope 101. For example, if the digitally-based, thermal scope 101 is powered off, a long push in of a “cap” configured into the control 202 can power on the digitally-based, thermal scope 101 (or conversely power off the digitally-based, thermal scope 101 if powered on). While looking through viewing optics 112 at the viewing computer display 110, rotary- and push-type actions of the control 202 can be used to navigate among displayed graphical user interface menus and select menu items. Any function provided by control 202 that is consistent with this disclosure is considered to be within the scope of this disclosure. In some implementations, a mobile computing device can be integrated with the digitally-based, thermal scope 101 (for example, using WIFI) and provide an interface (for example, with a software application) to permit alternative configuration of the digitally-based, thermal scope 101.

Data transfer interface turret 204 is used to provide data transfer interfaces (for example, USB 208 and WIFI 210) for the digitally-based, thermal scope 101. For example, in conjunction with the processing electronics 108, the described data transfer interface can provide WIFI, USB, streaming video, firmware upgrades, connectivity with mobile computing devices, control interfaces, and other functionality consistent with this disclosure and associated with the digitally-based, thermal scope 101. In some implementations, the data transfer interfaces (for example, USB 208) can be used to provide external power to the digitally-based, thermal scope 101 to power digitally-based, thermal scope 101 functionality or to recharge the internal rechargeable battery 114 or user-replaceable battery 116.

In some implementations, data transfer interface turret 204 is configured with a removable turret cap 206. In some implementations, the turret cap 206 can be a pop-off, friction-fit, or screw-type cap. In some implementations, the turret cap 206 can be retained to the digitally-based, thermal scope 101 using a wire loop, elastic band, or other retention mechanism to prevent the turret cap 206 from becoming separated from the digitally-based, thermal scope 101. In typical implementations, the turret cap 206 (or data transfer interface turret 204) is configured with one or more O-rings or other seals to provide a water- and dust-proof compartment for the associated data transfer interfaces.

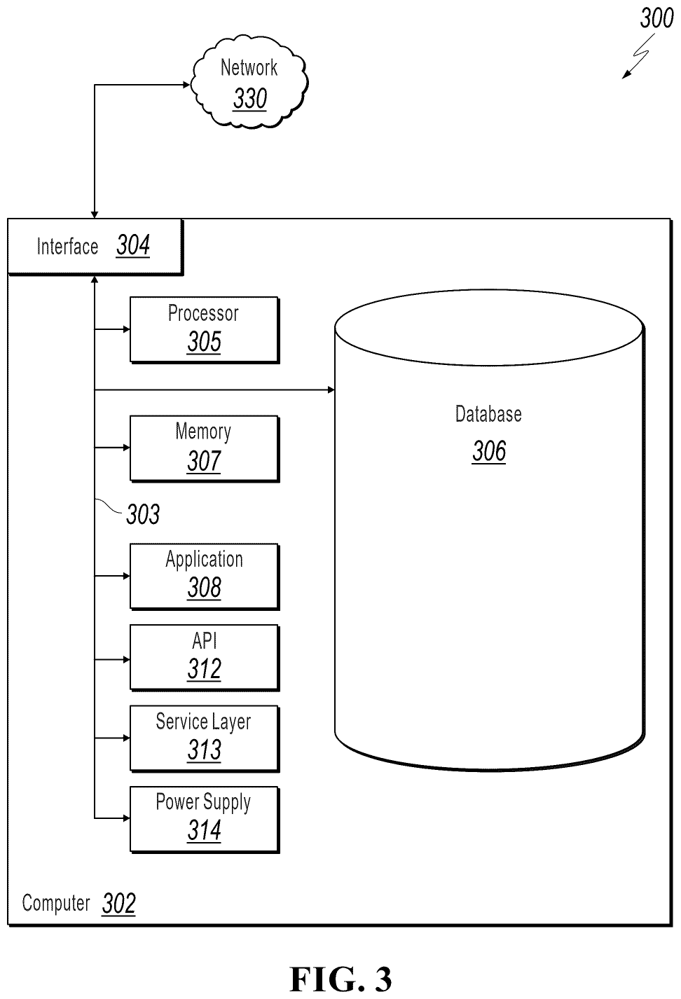

FIG. 3 is a block diagram illustrating an example of a computer-implemented system 300 (for example, representing or as part of processing electronics 108) used to provide computational functionalities associated with described algorithms, methods, functions, processes, flows, and procedures, according to an implementation of the present disclosure. In the illustrated implementation, system 300 includes a computer 302 and a network 330.

The illustrated computer 302 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the computer 302 can include an input device, such as a keypad, keyboard, touch screen, another input device, or a combination of input devices that can accept user information, and an output device that conveys information associated with the operation of the computer 302, including digital data, visual, audio, another type of information, or a combination of types of information, on a graphical-type user interface (UI) (or GUI) or other UI.

The computer 302 can serve in a role in a distributed computing system as a client, network component, a server, a database or another persistency, another role, or a combination of roles for performing the subject matter described in the present disclosure. The illustrated computer 302 is communicably coupled with a network 330. In some implementations, one or more components of the computer 302 can be configured to operate within an environment, including cloud-computing-based, local, global, another environment, or a combination of environments.

At a high level, the computer 302 is an electronic computing device operable to receive, transmit, process, store, or manage data and information associated with the described subject matter. According to some implementations, the computer 302 can also include or be communicably coupled with a server, including an application server, e-mail server, web server, caching server, streaming data server, another server, or a combination of servers.

The computer 302 can receive requests over network 330 (for example, from a client software application executing on another computer 302) and respond to the received requests by processing the received requests using a software application or a combination of software applications. In addition, requests can also be sent to the computer 302 from internal users (for example, from a command console or by another internal access method), external or third-parties, or other entities, individuals, systems, or computers.

Each of the components of the computer 302 can communicate using a System Bus 303. In some implementations, any or all of the components of the computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the computer 302 or other components (whether illustrated or not) that are communicably coupled to the computer 302. The functionality of the computer 302 can be accessible for all service consumers using the Service Layer 313. Software services, such as those provided by the Service Layer 313, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 302, alternative implementations can illustrate the API 312 or the Service Layer 313 as stand-alone components in relation to other components of the computer 302 or other components (whether illustrated or not) that are communicably coupled to the computer 302. Moreover, any or all parts of the API 312 or the Service Layer 313 can be implemented as a child or a sub-module of another software module, enterprise application, or hardware module without departing from the scope of the present disclosure.

The computer 302 includes an interface 304. Although illustrated as a single interface 304, two or more interfaces 304 can be used according to particular needs, desires, or particular implementations of the computer 302. The interface 304 is used by the computer 302 for communicating with another computing system (whether illustrated or not) that is communicatively linked to the network 330 in a distributed environment. Generally, the interface 304 is operable to communicate with the network 330 and includes logic encoded in software, hardware, or a combination of software and hardware. More specifically, the interface 304 can include software supporting one or more communication protocols associated with communications such that the network 330 or hardware of interface 304 is operable to communicate physical signals within and outside of the illustrated computer 302. In an example, interface 304 can include USB, FIREWIRE, or WIFI technologies.

The computer 302 includes a processor 305. Although illustrated as a single processor 305, two or more processors 305 can be used according to particular needs, desires, or particular implementations of the computer 302. Generally, the processor 305 executes instructions and manipulates data to perform the operations of the computer 302 and any algorithms, methods, functions, processes, flows, and procedures as described in the present disclosure.

The computer 302 also includes a database 306 that can hold data for the computer 302, another component communicatively linked to the network 330 (whether illustrated or not), or a combination of the computer 302 and another component. For example, database 306 can be an in-memory, conventional, or another type of database storing data consistent with the present disclosure. In some implementations, database 306 can be a combination of two or more different database types (for example, a hybrid in-memory and conventional database) according to particular needs, desires, or particular implementations of the computer 302 and the described functionality. Although illustrated as a single database 306, two or more databases of similar or differing types can be used according to particular needs, desires, or particular implementations of the computer 302 and the described functionality. While Database 306 is illustrated as an integral component of the computer 302, in alternative implementations, database 306 can be external to the computer 302.

The computer 302 also includes a memory 307 that can hold data for the computer 302, another component or components communicatively linked to the network 330 (whether illustrated or not), or a combination of the computer 302 and another component. memory 307 can store any data consistent with the present disclosure. In some implementations, memory 307 can be a combination of two or more different types of memory (for example, a combination of semiconductor and magnetic storage) according to particular needs, desires, or particular implementations of the computer 302 and the described functionality. Although illustrated as a single memory 307, two or more memories 307 or similar or differing types can be used according to particular needs, desires, or particular implementations of the computer 302 and the described functionality. While memory 307 is illustrated as an integral component of the computer 302, in alternative implementations, memory 307 can be external to the computer 302.

The Application 308 is an algorithmic software engine providing functionality according to particular needs, desires, or particular implementations of the computer 302, particularly with respect to functionality described in the present disclosure. For example, Application 308 can serve as one or more components, modules, or applications. Further, although illustrated as a single Application 308, the Application 308 can be implemented as multiple Applications 308 on the computer 302. In addition, although illustrated as integral to the computer 302, in alternative implementations, the Application 308 can be external to the computer 302.

The computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the computer 302 to be plugged into a wall socket or another power source to, for example, power the computer 302 or recharge a rechargeable battery.

There can be any number of computers 302 associated with, or external to, a computer system containing computer 302, each computer 302 communicating over network 330. Further, the term “client,” “user,” or other appropriate terminology can be used interchangeably, as appropriate, without departing from the scope of the present disclosure. Moreover, the present disclosure contemplates that many users can use one computer 302, or that one user can use multiple computers 302.

The computer 302 that is part of thermal imager 101 can perform image processing techniques to render a viewable image onto a view screen of the thermal imager. In some implementations, computer 302 includes an image processor. In some implementations, computer 302 can include a processor that performs image processing operations.

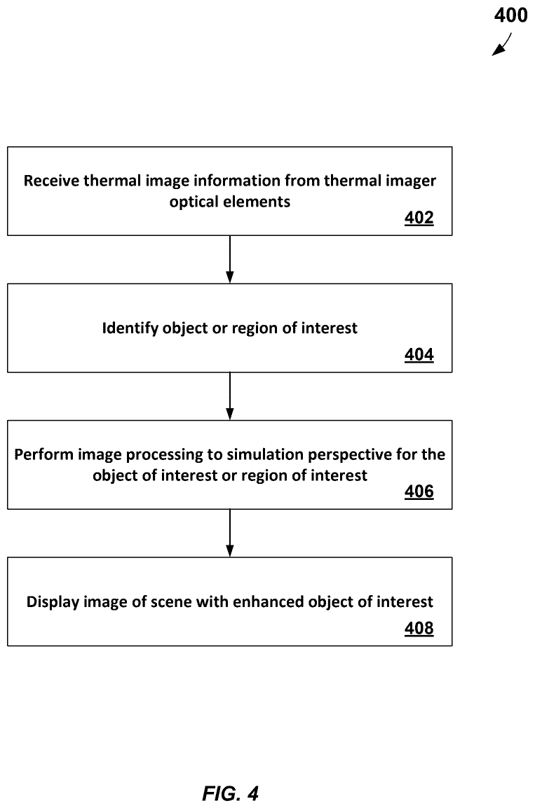

FIG. 4 is a process flow diagram for enhancing thermal images by simulating perspective in a thermal image displayed or output by the thermal imager in accordance with some implementations of the present disclosure. FIG. 4 illustrates an example of a set of operations 400 that may be performed for generating a 3D perception of captured thermal image in some implementations of the present technology.

In some implementations as illustrated in FIG. 4, operation 402 receives thermal image information from thermal imager optical elements and sensors. For instance, the thermal image information can be an image captured using receiving optics 104 and receiving optical sensor 106 that detect infrared radiation emitted by objects and create an image based on temperature differences. This captured thermal image provides the initial data for the subsequent image processing steps.

In some instances, the thermal image is captured by a camera, an imaging device, photo-sensors, photodetectors, and/or the like. For example, the camera configured to gather incoming electromagnetic radiation (for example, IR light) reflected from objects present in the image to be captured.

In some implementations, the thermal imager may be configured to may be constantly capturing multiple images, and/or videos. These streams images and/or videos may be stored locally on the devices and/or within a local or cloud-based storage platform connected using a network. These streams can be accessed in real-time from local devices (e.g., by a thermal imager). In some cases, the devices may be pushing the streams in real-time or in batches to the local and/or cloud-based system. In other cases, a supervisory system may be monitoring the location of devices and requesting streams needed for processing.

Operation 404 involves determining an object of interest within the thermal image. In some instances, the operation may involve selecting multiple objects and/or a region of interest (ROI). For example, after the thermal image is captured, an object of interest is selected within the captured thermal image. The image processing algorithms are then implemented using a computer (for e.g., computer-implemented system 300).

The concept of an object of interest is not limited to one single object or type of object. A user can select an object or type of object to enhance. A user can also select a category or class of objects to enhance, such as “mammals” or “vehicles.” Object recognition techniques can be used to selectively enhance objects with perspective simulation.

The object selection can be performed manually by a user and/or automatically using computer vision algorithms. The manual object selection may be performed through an interactive user interface. Users can select objects displayed on a screen by interacting with touch-sensitive devices such as, but not limited to, touchpads, touchscreen displays, capacitive touchscreens, resistive touchscreens, physical buttons, capacitive buttons, any other touch-sensitive input mechanisms, and/or the like. Users can engage with these interactive components to precisely designate and interact with objects displayed on a screen or monitor.

In the case of a touchpad or touchscreen, users can make object selections by touching, tapping, swiping, and/or using gestures to navigate and pinpoint the desired object. The user interface translates these input actions into electronic signals, enabling the selection of objects with a high degree of accuracy. Additionally, physical buttons can be customized to designate specific objects or perform selection actions, providing an alternative and tactile means of object selection. A user can also link the optical device with a computing system, such as a smartphone, laptop, desktop, tablet, or other computing system, and interface with the optical device through the computing system. In some implementations, the optical device can include a wireless communication device. The user can access online databases through the optical device itself using an on-board interface, or the user can link wirelessly to the optical device via a user device. In addition to being able to make selections of the object(s) or region(s) of interest, the user can also select a type of enhancement for simulating perspective of the object(s) or region(s) of interest. For example, a user can select background blurring or certain types of shading, or a combination of both.

In case of automatic object selection using image processing algorithms, upon receiving a thermal image from operation 402, the image processing algorithms systematically scan the image data, identifying thermal variations that suggest the presence of objects. The algorithms then delineate these objects by creating ROI boundaries, enabling precise object selection. The automatic selection process greatly reduces the need for manual user input and enhances the speed and accuracy of selecting objects within thermal imagery.

In some implementations, the automatic selection of objects within thermal images is achieved using machine learning-based image processing algorithms. These algorithms are trained on diverse datasets, allowing them to learn, adapt, and improve their ability to recognize thermal objects over time. By continuously learning and evolving, these machine learning algorithms adapt to new thermal object profiles and offer improved accuracy in automated object selection.

Operation 406 involves enhancing objects selected (in operation 404) within the captured thermal image by adding three-dimensional (3-D) perspective information.

The image processing techniques applied to enhance the selected object with three-dimensional perspective information may include, but are not limited to, depth estimation, texture mapping, lighting and shading, perspective correction, background and/or foreground blurring, contrast and/or brightness variations, background flatting, and/or the like.

In some implementations, a depth estimation algorithm may be applied to determine the spatial position of the selected object relative to the camera. This algorithm uses temperature variations across the object to estimate its distance from the camera, thus providing crucial depth information.

In some implementations, a texture mapping process may be used to overlay a 3-D texture on the selected object. This texture is generated based on the temperature distribution across the object's surface and the depth information obtained from the depth estimation. It allows the object to appear three-dimensionally textured in the enhanced image.

In some implementations, to further enhance the 3-D appearance of the object, lighting and shading effects may be applied. These effects consider the object's depth and the thermal radiation patterns to realistically simulate the play of light and shadow on the object's surface. Further, in some implementations, a user may be able to modify the lighting and shading characteristics on the selected object within the thermal image.

Other implementations may allow users to add custom controls for adjusting the directionality of the light source in thermal images, thus, offering a way to enhance visualization of the selected thermal objects within its thermal image.

In some implementations, users can manipulate controls to change the angle and intensity of the virtual light, resulting in real-time modifications to the shading and illumination of objects in the image. The image processing technique may be implemented using a model that calculates and applies the appropriate changes to the light and shading patterns across the image, based on the user's input. This allows users to effectively add light and shadow onto the thermal image, enabling creative and functional customization.

In some implementations, on-board sensors such as gyroscopes, compasses, GPS, or other positioning or location sensors can be used to artificially create light sources that dynamically change when the optical device changes direction. This way, the resulting images displayed begin to resemble images from visible-light devices or what a human eye perceives. For example, if the optical device is facing a first direction, and an artificial light source is created to cast a shadow on a first object based on that first direction, then as the optical device yaws to face another, second direction, a shadow can be created on another object that is rotated based on the change between the first direction and the second direction. By moving the shadow dynamically based on the position of the optical device, the resulting image begins to resemble a visible-light, 3-D image.

In some implementations, perspective correction techniques may be used to adjust the size and orientation of the selected object within the image, ensuring that it aligns correctly with the 3-D perspective information.

Enhancing of the selected object image processing may involve but is not limited to contrast enhancement (for e.g., histogram equalization, adaptive histogram equalization, etc.), sharpening, smoothing and noise reduction (for e.g., Gaussian blur, median filtering, etc.), edge detection and segmentation (for e.g., canny edge detection, Sobel operator, etc.), color enhancement (for e.g., color balance adjustment, selective color adjustment, etc.), retouching and spot removal (for e.g., clone stamp tool, etc.), local adaptive method, super-resolution for IR images, denoising techniques, anomaly detection algorithms, and/or the other methods implemented in enhancing objects in an image.

In other implementations, machine learning techniques (ML) and/or artificial intelligence (AI) may be utilized to enhance the selected object with three-dimensional perspective information. The ML and AI for enhancing selected object may involve, but is not limited to, deep learning based super-resolution, object detection and segmentation, transfer learning for feature extraction, style transfer for IR enhancement, adaptive contrast enhancement, attention mechanism for object enhancement, and/or the other ML/AI methods implemented in enhancing objects in an image.

The deep learning-based super-resolution may utilize trained neural networks (such as convolutional neural networks or CNNs) to upscale thermal images, enhancing object details and overall image quality through learned features. Trained neural networks can also be used to estimate depth maps from 2D images, including 2D thermal images. For example, 3D from 2D neural network models, alone or in combination with image recognition processing, can be used to estimate depth maps from two-dimensional thermal images. The neural network can be fed the thermal images directly for shape, object, pattern, and/or location matching. If the neural network is sufficiently trained, the neural network can create a depth map from the thermal image directly. The imager can use monocle and stereo depth estimation networks to aid in image recognition tasks.

A thermal image can undergo image processing for object or shape recognition. The object or shape recognition can then be used by the 3D to 2D neural network to estimate depth of objects from the thermal image based on the neural network image recognition capabilities. The neural network's access to one or more libraries of 2D and 3D images allows the neural network to perform object or shape matching, pattern matching, scene matching, etc. The neural network can then be used to create a depth map of the scene based on the information from the 2D and 3D libraries. The thermal image can be augmented by a depth map to enhance the thermal image with 3D perception. This can be done for one or more objects in the scene captured by the thermal imager.

Object or shape recognition can also be used with neural networks for location identification and visualization. Objects and shapes within a scene captured in a thermal image can be fed into a neural network that can determine a location of the operator of the imaging device. For example, the shapes of buildings can be compared against images of known skylines, and dimensional information from known skylines can be used to augment the two dimensional thermal image with perspective information.

Location information can also be determined from satellite-based global positioning or navigation services, such as GPS or GNSS information. An imaging device can include a GPS or other type of positioning system on-board, which can provide location information to the image processor and/or neural network. The image processing or neural network can use that information to determine a location of the imaging device, identify known object dimensional information to the objects in the scene from the location and from object recognition, and augment the thermal image with perspective information. Location information can also be used to obtain depth maps that have already been created, which the image processor can use to generate perspective enhancement for the two-dimensional thermal image.

Location can be determined using other, non-satellite based technology. For example, static radio masts can be used for location via triangulation of the imaging device. Cellular services or other radio network technologies can be used that include radio-based location services can also be used.

Once a depth map of the scene has been determined or estimated, and in some implementations, location services can provide other information about the scene, including a top-down view, the image device can generate a birds-eye view that an operator can use to “fly over” the scene to simulate a zoom and to gain a broader perspective of the estimated location of the various objects in the scene.

For example, the depth map can be used to estimate the relative positions and sizes of each of the objects in the scene. From the depth map, as well as form the original 2D image, the imaging device can simulate a birds-eye view of the scene. The birds-eye view can be manipulated by the operator to zoom in (e.g., from the top down) onto certain portions of the thermal image. This can be done using a touchscreen interface or other type of interface. The operator can even rotate the birds-eye view of the thermal image along different axes of rotation to change the viewing perspective.

By adding additional information, such as location information or other two and three dimensional images of the scene (e.g., via neural network accessing libraries of data), additional details and accuracy can be added to the birds-eye view of the scene.

Other perspective enhancements can be added to the thermal image, including realistic shading and shadowing based on the location of the operator and the time of day, adding parallax to add realistic motion to the thermal image,

Object detection and segmentation techniques may involve training object detection models (like Faster R-CNN or YOLO) on annotated thermal image data to accurately locate and highlight specific objects in thermal images.

Transfer learning for feature extraction techniques may adapt pre-trained deep learning models (such as ResNet or VGG) to extract relevant features from thermal images, aiding in better object recognition.

Style transfer for IR enhancement may apply style transfer techniques to adjust the visual appearance of IR images, emphasizing object details and improving overall aesthetics.

Adaptive contrast enhancement may use reinforcement learning to adaptively adjust contrast enhancement parameters in real-time, optimizing object visibility in varying conditions.

Attention mechanisms for object enhancement may incorporate attention mechanisms in deep models to focus on relevant object regions, enhancing their representation and visibility.

It is understood that an image processing may involve some of techniques or a combination of multiple techniques to enhance the 3-D perspective of the selected object in the captured thermal image. Thus, the methods described herein may be combined in all possible combinations of methods, apparatus, modules, systems, computer program, and/or the like.

The optical device can also project depth and perspective to distinguish two objects that would appear to overlap in a 2-D image, but in reality are separated by a space (i.e., one object is physically in front of the other). Object depth differentiation becomes feasible by recognizing thermal variations that indicate the presence of distinct objects. Moreover, employing edge detection techniques assists in accentuating the boundaries of the overlapping objects. Additionally, the utilization of machine learning/artificial intelligence (ML/AI) methods can aid in the identification of these two overlapping objects, allowing for the application of object-enhancing techniques. Ultimately, the effectiveness of distinguishing the two overlapping objects is determined by several factors, such as the depth of the objects, the degree of overlap, and more. In this context, the application of lighting and shading effects proves to be an effective strategy for differentiation.

Following the execution of operation 406, the computer 302 generates at least one thermal image with three-dimensional (3-D) perspective, thereby offering a highly informative and improved visualization of the chosen objects within the thermal image.

Operation 408 involves displaying the enhanced thermal image, by overlaying and/or superimposing onto the original thermal image. This overlaying process aligns the enhanced object precisely with its original position within the thermal scene, ensuring seamless integration. For instance, a thermal image is processed by processing electronics 108 into image data to be recreated/represented on viewing computer display 110, and viewed through viewing optics 112. The display can display the image of the scene with the enhanced object of interest. The display can display the images of the scene as a real-time video, such as a viewfinder on a digital optical device would display a real-time video. The simulation of perspective on the object of interest would adjust based on the movement of the optical device relative to the object of interest. In addition, simulation of perspective is added to new objects of interest as they appear in view.

In other implementations, instead of overlaying, the processing electronics 108 may create a new image that may be recreated/represented on viewing computer display 110.

In some implementations, the enhanced thermal image may be displayed on multiple screens.

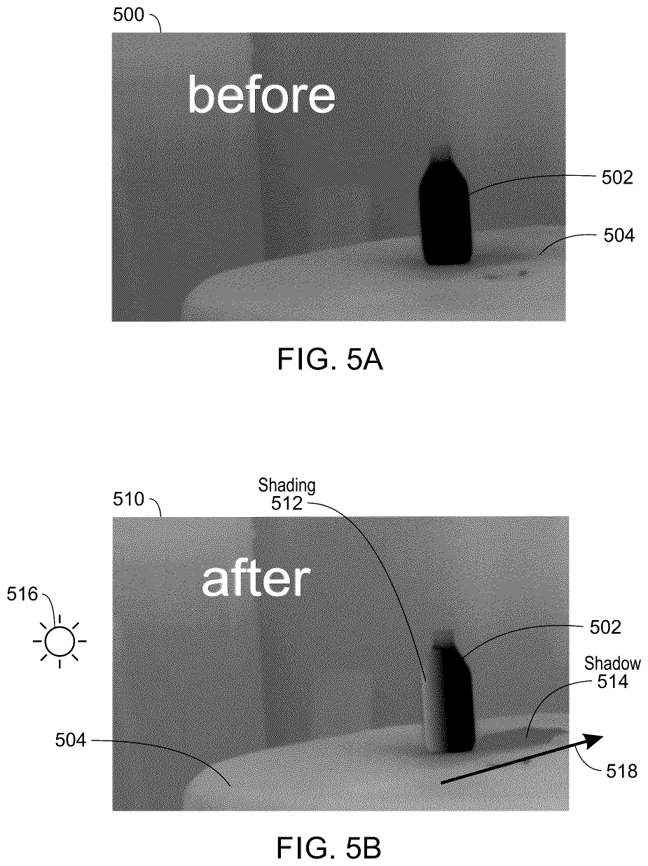

FIGS. 5A-4B are an example thermal images before and after perspective simulation enhancement in accordance with some implementations of the present disclosure. FIG. 5A illustrates a thermal image 500 that includes an example object of interest 502. The object of interest 502 in this example is a bottle. The object of interest 502 is resting on a surface 504. As shown in the thermal image 500, the object of interest is shown as a solid black object with some slight brightness variation near that top. In general, the object of interest 502 does not possess any perspective simulation. The object of interest 502 can be identified based on a category of objects selected by the user. Or the optical device can automatically determine the object of interest based on a pre-selected category of objects. Or the optical device can determine that the bottle is an object of interest using built-in intelligence, such as AI or machine learning. For example, the bottle is the only image in the room that is entirely dark. Or the AI/machine learning can determine that the bottle is an object as opposed to a flat surface, like the table. In any case, the optical device can recognize the object of interest 502 as being of interest for perspective simulation.

The optical device can then perform image processing, as described herein, to add perspective to the bottle. The perspective, in this case, can be based on user-selection, predefined enhancements for bottles in general, or intelligent decisions about how best to simulate perspective for an object having the shape of a bottle. For example, a bottle can appear to be curved, like a cylinder with a tapered neck. The simulation of perspective can rely on the shape of the object of interest 502 to determine how to modify pixels that make up the object to best add shading based on the object having a curved shape. As shown in FIG. 5B, the object of interest 502 is altered to have shading 512 based on a varying brightness from the left side of the bottle (brighter) to the right side of the bottle (darker). The shading 512 using varying of the brightness across the face of the bottle gives the object of interest 502 a curved perspective. Contrast that with a more abrupt change in relative brightness, which might be useful for shape with a sharper edge transition from one side to another, like a box. Thus, the type of object itself can be used to determine how to apply a desired perspective simulation.

In addition, the differentiation between the object of interest 502 and the surface 504 can also be used to simulate perspective. In this example, an area adjacent to the object of interest 502 is altered to create a shadow 514 of the object of interest 502 on the surface 504. The shadow 514 is created with a size and shape to match the shading 512. For example, to create shading, an artificial light source 516 can be simulated. The artificial light source 516 does not need to appear in the image. When creating shading 512, the artificial light source 516 can be simulated having a particular position and intensity. The shading 512 on the object of interest 502 can be determined based on the location and intensity of the artificial light source 516. Moreover, the size, shape, and direction (direction shown by arrow 518) of the shadow 514 can also be based on the position and intensity of the artificial light source 516. As shown in FIG. 5B, the shadow 514 is angled slightly upwards (arrow 518).

Optionally, the position of the light source 516 can be virtually fixed, so that if the optical device moves (i.e., yaws), the shadow 514 can change. By dynamically adjusting the shadow position, size, shape, etc. based on the relative angle between the object of interest and the imager, the simulation of depth can appear even more realistic.

Other enhancements can also be applied. For example, the background can be blurred or darkened. These steps are aligned with the overall goals of this disclosure, which are to provide an enhancement to the object or region of interest and providing perspective for the object of interest or objects within the region of interest.

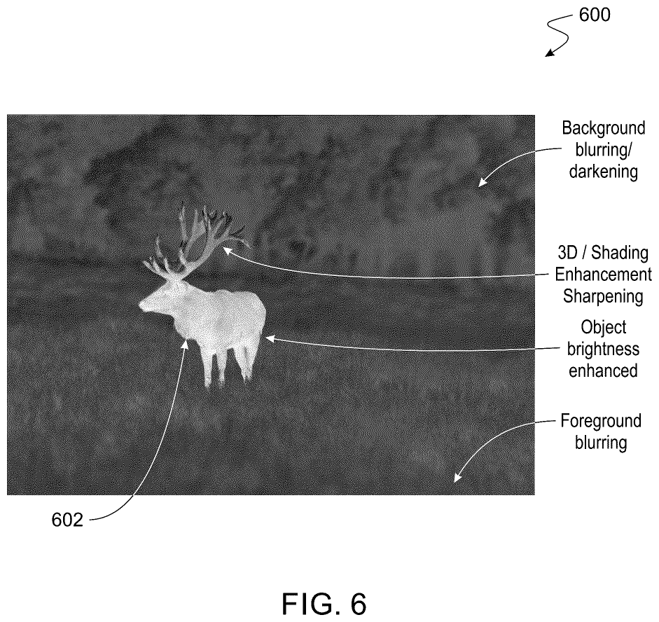

FIG. 6 is an example infrared image 600 that includes several image processing techniques that add perspective enhancement in accordance with some implementations of the present disclosure. In FIG. 6, an infrared image of an elk 602, which is the object of interest in this example scenario. As indicated by FIG. 6, several features of the entire scene are processed to provide perspective enhancement to the object of interest—the elk 602. For example, the background of the image has been blurred and darkened so that the elk 602 stands out by comparison. The elk 602 itself can be brightened to further add contrast to the background. The antlers of the elk can be sharpened to provide contrast and image enhancement for the user, but also for image recognition to provide information about the elk to the user. The antlers can also be enhanced using shading to add a three dimensionality and depth to the antlers. In addition, foreground blurring and darkening can be implemented to further cause the elk 602 to stand out.

Described implementations of the subject matter can include one or more features, alone or in combination, as described in the following examples:

Example 1 is a method for performing image processing on an object in a scene to add perspective enhancement to the object, the method including receiving, at an optical sensor of an optical device, electromagnetic radiation reflected from a scene; generating, by an image processor, a digital image of the scene from the received infrared radiation; identifying, by the image processor, an object of interest within the digital image of the scene; altering, by the image processor, the object of interest to add dimensional perspective to the object of interest in the digital image; and displaying, on a display of the optical device, the digital image of the scene with the object of interest.

Example 2 may include the subject matter of example 1, wherein altering the object of interest to add dimensional perspective to the object of interest comprises varying the brightness level of the object of interest to add a shading effect to the object of interest.

Example 3 may include the subject matter of example 2, the method also including identifying a region of interest adjacent to the object of interest; and changing a brightness level of the region of interest adjacent to the object of interest to add a shadow effect to the region of interest adjacent to the object of interest.

Example 4 may include the subject matter of any of examples 1-3, wherein the object of interest is a first object of interest, and the method further includes identifying a second object of interest from the digital image of the scene; determining that the second object of interest is behind the first object of interest; altering the second object of interest to add dimensional perspective to the object of interest in the digital image based on the second object of interest being behind the first object of interest; and displaying the second object of interest on the display.

Example 5 may include the subject matter of example 4, wherein altering the second object of interest to add dimensional perspective to the object of interest in the digital image based on the second object of interest being behind the first object of interest includes accentuating a boundary between the first object of interest and the second object of interest using edge detection.

Example 6 may include the subject matter of any of examples 4 or 5, wherein altering the second object of interest to add dimensional perspective to the object of interest in the digital image based on the second object of interest being behind the first object of interest includes performing dynamic focus adjustment on the second object of interest to add a blur to the second object of interest, the blur to create a perception that the second object of interest is out of focus.

Example 7 may include the subject matter of any of examples 4-6, wherein altering the second object of interest to add dimensional perspective to the object of interest in the digital image based on the second object of interest being behind the first object of interest includes increasing the relative brightness of the first object of interest relative to the brightness of the second object of interest.

Example 8 may include the subject matter of any of examples 1-7, the method further including identifying a background of the scene; and blurring the background of the scene to enhance the object of interest.

Example 9 may include the subject matter of example 8, the method further including enhancing the focus of the object of interest.

Example 10 may include the subject matter of any of examples 1-9, the method further including identifying a background of the scene; isolating the object of interest from the background of the scene; and flatting the background of the scene to enhance the object of interest.

Example 11 is an optical device that includes an optical sensor to receive electromagnetic radiation reflected from a scene; an image processor to comprising hardware circuitry; a memory for storing instructions that when executed cause the image processor to perform operations that include generating a digital image of the scene from the received infrared radiation, identifying an object of interest within the digital image of the scene, and altering the object of interest to add dimensional perspective to the object of interest in the digital image; and a display screen to display the digital image of the scene with the altered object of interest.

Example 12 may include the subject matter of example 11, wherein altering the object of interest to add dimensional perspective to the object of interest includes varying the brightness level of the object of interest to add a shading effect to the object of interest.

Example 13 may include the subject matter of any of examples 11-12, the operations further including identifying a region of interest adjacent to the object of interest; and changing a brightness level of the region of interest adjacent to the object of interest to add a shadow effect to the region of interest adjacent to the object of interest.

Example 14 may include the subject matter of any of examples 11-13, wherein the object of interest is a first object of interest, and the operations further comprising identifying a second object of interest from the digital image of the scene; determining that the second object of interest is behind the first object of interest; altering the second object of interest to add dimensional perspective to the object of interest in the digital image based on the second object of interest being behind the first object of interest; and displaying the second object of interest on the display.

Example 15 may include the subject matter of example 14, wherein altering the second object of interest to add dimensional perspective to the object of interest in the digital image based on the second object of interest being behind the first object of interest includes accentuating a boundary between the first object of interest and the second object of interest using edge detection.

Example 16 may include the subject matter of any of examples 14 or 15, wherein altering the second object of interest to add dimensional perspective to the object of interest in the digital image based on the second object of interest being behind the first object of interest includes performing dynamic focus adjustment on the second object of interest to add a blur to the second object of interest, the blur to create a perception that the second object of interest is out of focus.

Example 17 may include the subject matter of any of examples 14-16, wherein altering the second object of interest to add dimensional perspective to the object of interest in the digital image based on the second object of interest being behind the first object of interest includes increasing the relative brightness of the first object of interest relative to the brightness of the second object of interest.

Example 18 may include the subject matter of any of examples 11-17, the operations further including identifying a background of the scene; and blurring the background of the scene to enhance the object of interest.

Example 19 may include the subject matter of example 18, the operations further including enhancing the focus of the object of interest.

Example 20 may include the subject matter of any of examples 11-19, the operations further including identifying a background of the scene; isolating the object of interest from the background of the scene; and flatting the background of the scene to enhance the object of interest.

Example 21 may include the subject matter of any of examples 11-19, wherein the optical device is a rifle scope or a spotting scope.

Example 22 is an optical device configured to perform the method steps of any of claims 1-10.

Example 23 is an optical device configured to perform one or more operations described in the specification.

1. A method comprising:
receiving, at an optical sensor of an optical device, electromagnetic radiation reflected from a scene;
generating, by an image processor, a digital image of the scene from the received infrared radiation;
identifying, by the image processor, an object of interest within the digital image of the scene;
altering, by the image processor, the object of interest to add dimensional perspective to the object of interest in the digital image; and
displaying, on a display of the optical device, the digital image of the scene with the object of interest.

2. The method of claim 1, wherein altering the object of interest to add dimensional perspective to the object of interest comprises varying the brightness level of the object of interest to add a shading effect to the object of interest.

3. The method of claim 2, further comprising:
identifying a region of interest adjacent to the object of interest; and
changing a brightness level of the region of interest adjacent to the object of interest to add a shadow effect to the region of interest adjacent to the object of interest.

4. The method of claim 1, wherein the object of interest is a first object of interest, and the method further comprises:
identifying a second object of interest from the digital image of the scene;
determining that the second object of interest is behind the first object of interest;
altering the second object of interest to add dimensional perspective to the object of interest in the digital image based on the second object of interest being behind the first object of interest; and
displaying the second object of interest on the display.

5. The method of claim 4, wherein altering the second object of interest to add dimensional perspective to the object of interest in the digital image based on the second object of interest being behind the first object of interest comprises:
accentuating a boundary between the first object of interest and the second object of interest using edge detection.

6. The method of claim 4, wherein altering the second object of interest to add dimensional perspective to the object of interest in the digital image based on the second object of interest being behind the first object of interest comprises:
performing dynamic focus adjustment on the second object of interest to add a blur to the second object of interest, the blur to create a perception that the second object of interest is out of focus.

7. The method of claim 4, wherein altering the second object of interest to add dimensional perspective to the object of interest in the digital image based on the second object of interest being behind the first object of interest comprises:
increasing the relative brightness of the first object of interest relative to the brightness of the second object of interest.

8. The method of claim 1, further comprising:
identifying a background of the scene; and
blurring the background of the scene to enhance the object of interest.

9. The method of claim 8, further comprising enhancing the focus of the object of interest.

10. The method of claim 1, further comprising:
identifying a background of the scene;
isolating the object of interest from the background of the scene; and
flatting the background of the scene to enhance the object of interest.

11. An optical device comprising:
an optical sensor to receive electromagnetic radiation reflected from a scene;
an image processor to comprising hardware circuitry;
a memory for storing instructions that when executed cause the image processor to perform operations comprising:
generating a digital image of the scene from the received infrared radiation,
identifying an object of interest within the digital image of the scene, and
altering the object of interest to add dimensional perspective to the object of interest in the digital image; and
a display screen to display the digital image of the scene with the altered object of interest.

12. The optical device of claim 11, wherein altering the object of interest to add dimensional perspective to the object of interest comprises varying the brightness level of the object of interest to add a shading effect to the object of interest.

13. The optical device of claim 12, the operations further comprising:
identifying a region of interest adjacent to the object of interest; and
changing a brightness level of the region of interest adjacent to the object of interest to add a shadow effect to the region of interest adjacent to the object of interest.

14. The optical device of claim 11, wherein the object of interest is a first object of interest, and the operations further comprising:
identifying a second object of interest from the digital image of the scene;
determining that the second object of interest is behind the first object of interest;
altering the second object of interest to add dimensional perspective to the object of interest in the digital image based on the second object of interest being behind the first object of interest; and
displaying the second object of interest on the display.

15. The optical device of claim 14, wherein altering the second object of interest to add dimensional perspective to the object of interest in the digital image based on the second object of interest being behind the first object of interest comprises:
accentuating a boundary between the first object of interest and the second object of interest using edge detection.

16. The optical device of claim 14, wherein altering the second object of interest to add dimensional perspective to the object of interest in the digital image based on the second object of interest being behind the first object of interest comprises:
performing dynamic focus adjustment on the second object of interest to add a blur to the second object of interest, the blur to create a perception that the second object of interest is out of focus.

17. The optical device of claim 14, wherein altering the second object of interest to add dimensional perspective to the object of interest in the digital image based on the second object of interest being behind the first object of interest comprises:
increasing the relative brightness of the first object of interest relative to the brightness of the second object of interest.

18. The optical device of claim 11, the operations further comprising:
identifying a background of the scene; and
blurring the background of the scene to enhance the object of interest.

19. The optical device of claim 18, the operations further comprising enhancing the focus of the object of interest.

20. The optical device of claim 11, the operations further comprising:
identifying a background of the scene;
isolating the object of interest from the background of the scene; and
flatting the background of the scene to enhance the object of interest.

21. The optical device of claim 11, wherein the optical device is a rifle scope or a spotting scope.
